(19) United States
(12) Patent Application Publication
(10) Pub. No.: US 2005/0228690 A1
(43) Pub. Date: Oct. 13, 2005

(54) Generic architecture for adaptable software

(76) Inventor: Paul Guignard, Batemans Bay (AU)

Correspondence Address: DLA PIPER RUDNICK GRAY CARY US, LLP, 2000 University Avenue, E. Palo Alto, CA, 94303-2248, US

(21) Appl. No.: 10/450,974

(22) PCT Filed: Dec. 19, 2001
(86) PCT No.: PCT/AU01/01630

§ 371 Date: Feb. 23, 2004

(30) Foreign Application Priority Data
Dec. 19, 2000 (AU) PR2151
Aug. 20, 2001 (AU) PR7090

(51) Int. Cl. G06F 17/60

(52) U.S. Cl. 705/2

(57) ABSTRACT

This invention concerns adaptable software. In particular it concerns a method for constructing an adaptable soft-ware application. A first step involves instantiating a first set of knowledge elements (kitems) related to the type of business objects or operations which will be handled by the adaptable software application, from a knowledge application development environment identifying the business needs of the application and used to produce dynamic and flexible templates. A second step involves instantiating a second set of kitems related to business objects, from the first set by specifying parameters to determine the features of the business objects. In a further aspect it concerns an adaptable software application comprising at least two levels of instantiation, where the templates for the second level instantiations are the first level instantiations.

### TECHNICAL FIELD

This invention concerns adaptable software. In particular it concerns a method for constructing an adaptable software application. In a further aspect it concerns an adaptable software application.

### BACKGROUND ART

An application is a software package designed for the manipulation, management and processing of business elements or objects. These are often, but not exclusively, documents. Manipulation, management and processing covers operations such as definition, access, editing, display, distribution, etc.

Such applications are normally hard-coded using standard programming techniques. The knowledge of the business requirements to be met by the application is designed into the architecture of the application and the code itself. The consequence of this approach is that systems are difficult to design and develop. They are also difficult to maintain and modify. When change is required to software, due to changing business conditions for example, designers must carry out extensive redesign and coding. In many cases, the effort is so difficult and time consuming that it is not attempted.

Another approach is to develop an expert system in which the business rules are separate from the hard-coded part of the application. This has the advantage that the business rules can, in principle, be changed without having to change the application. In practice, the process of entering and testing the rules is difficult and time consuming, and their reliability can only be ascertained through extensive testing. Expert systems are used to build only these applications for which knowledge is explicit and available, and where the effort required to enter and maintain the rules is clearly offset by big savings during operations. The difficulties associated with developing, implementing and maintaining expert systems are well documented in the expert system literature of the past twenty years. Few applications use expert systems technology; it is a niche technology.

A further approach is to build knowledge applications as described in co-pending Australian patent application PR2152 entitled Generic Knowledge Agents, International patent application PCT/AU99/00501 entitled Generic Knowledge Management System, and International patent application PCT/AU01/01155 entitled Intelligent Courseware Development and Delivery. The contents of these three applications are incorporated into this specification by reference.

A computerised generic knowledge management system, comprises:
a multi-dimensional global space within computer memory defined by attributes, where each attribute defines a feature of the external world or the internal state of the system, or actions that can be taken to modify them, and each attribute is a dimension of the global space;
a source space, within the global space, made up of selected ones of the attributes to define a context in which to state problems;
a destination space, within the global space, made of selected ones of the attributes to define a context in which to provide answers to problems stated in the source space;
mappings between defined parts of the source space which each represent one or more stated problems, to defined parts of the destination space which each represent one or more answers expressing and embodying knowledge supplied by experts appropriate to the respective problems stated in the part of the source space.

The process for building knowledge applications starts in a knowledge application development environment where the business needs of the application determine the knowledge elements, or ‘kitems’, to be instantiated, or created, from contexts and templates. The outcome is an application or knowledge base in which the kitems are regions, knowledge items etc in the application—one can think of these kitems as documents. A knowledge application is typically characterised by a single instantiation process for all the kitems.

The kitems can also be used as contexts or templates from which further kitems can be instantiated.

Once the knowledge application is built the kitems can be accessed and managed, that is edited, displayed, distributed, etc. This entails defining an enquiry in a consultation process that retrieves the knowledge elements of interest for perusal and further manipulation. The enquiry is itself a kitem instantiated from a kitem template.

Although designed and implemented in a radically different way from traditional expert systems, the business role of these knowledge applications and the way knowledge is accessed are similar to that of expert systems.

### SUMMARY OF THE INVENTION

The invention, in a first aspect, is a method for constructing an adaptable software application, comprising the steps of:

Instantiating a first set of kitems related to the type of business objects or operations which will be handled by the adaptable software application, from a knowledge application development environment identifying the business needs of the application.

Instantiating a second set of kitems related to business objects, from the first set by specifying parameters to determine the features of the business objects.

The first level of knowledge and the corresponding instantiations in effect produce dynamic templates that work as dynamic adaptations to the needs of users. Alternatively, these templates can be activated manually.

The business objects in an application are treated as knowledge elements that embody business knowledge, such as knowledge about events that took place, or are expected to take place, in the business. The business objects are easily created, and can be easily manipulated. Because business objects are knowledge elements, they can be easily managed, that is accessed, displayed, analysed, etc.

Instantiating the second set of kitems may take place dynamically, during the use of the application.

Applications can be built with a greater number of cascades or instantiations larger than two.

Enquiries can be directed against kitems at any level of instantiation using a consultation process.

The business objects may be accessed using a consultation process during use of the application.

The kitems related to the type of business objects may be accessed for inspecting and managing the design of the application.

The invention, in a second aspect, is an adaptable software application, comprising:
at least two levels of instantiation, where the templates for the second level instantiations are the first level instantiations.

The use of a two level instantiation, or cascading, design enables the first level to define the application without hard-coding, and the second to define the documents that are handled by the application. So, adaptable software transforms the definition of the application into specifying a knowledge application, and treats its documents (or business objects) as knowledge items inside the application.

The application may involve adaptable, intelligent modules or agents that communicate with each other, where each module has its business logic defined and implemented using the adaptable architecture of the system. This means that each module can be quickly developed and that its functionality can evolve with the business and with experience. Each adaptable module implements the knowledge about the best way to run that module. These modules are used to facilitate development and to increase the functionality and adaptability of the solution.

An adaptable meta-module may define and implement the logic between the other modules. In addition the meta-module may monitor a part of, or the whole chain of modules.

This software is able to adapt itself automatically using the knowledge entered into it, without programming, to determine when and how it should adapt; that is, modify its behaviour. It may also adapt dynamically to the needs of users as software is being used.

Adaptablability is a very important commercial feature for software. It holds the promise of speeding up software development, implementation, customization and flexibility. In addition to RAD (Rapid Application Development), adaptable software holds the promise of software that can be modified easily during all stages of its life-cycle, without major effort or redesign. Adaptable software also holds the promise of software that can adapt itself, that is customize itself and evolve as needs change while it is being used.

Adaptable software has the potential to save, worldwide, enormous sums in development costs, and to reduce the total cost of ownership of software solutions over their lifetimes.

Using adaptable software generic applications can be quickly produced. The frameworks for a variety of generic applications, for a variety of domains, can be quickly produced. An application framework is a knowledge system in which the knowledge elements express the knowledge about what the application is meant to do.

Also client specific applications can be quickly produced. Knowledge in generic framework can be easily modified or added to, so as to represent the knowledge about a client's specific requirements.

### BRIEF DESCRIPTION OF THE DRAWINGS

An example of the invention will now be described with reference to the accompanying drawings, in which:

FIG. 1 is a block diagram showing the steps in the construction and use of an adaptable software application.

FIG. 2 is a block diagram showing the architecture of an adaptable software application.

### BEST MODES OF THE INVENTION

Adaptable software differs from the knowledge applications described in the background art in that there are at least two levels of instantiation instead of one; and the templates for the second level instantiations are the first level instantiations (they can be objects and not classes in object oriented programming). Adaptable software extends the architecture of known knowledge applications.

The use of a two level instantiation, or cascading, design enables the first level to define the application (without hard-coding) and the second to define the documents that are handled by the application. Adaptable software transforms the definition of the application (typically hardcoded) into specifying a knowledge application, and treats its documents (or business objects) as knowledge items inside the application.

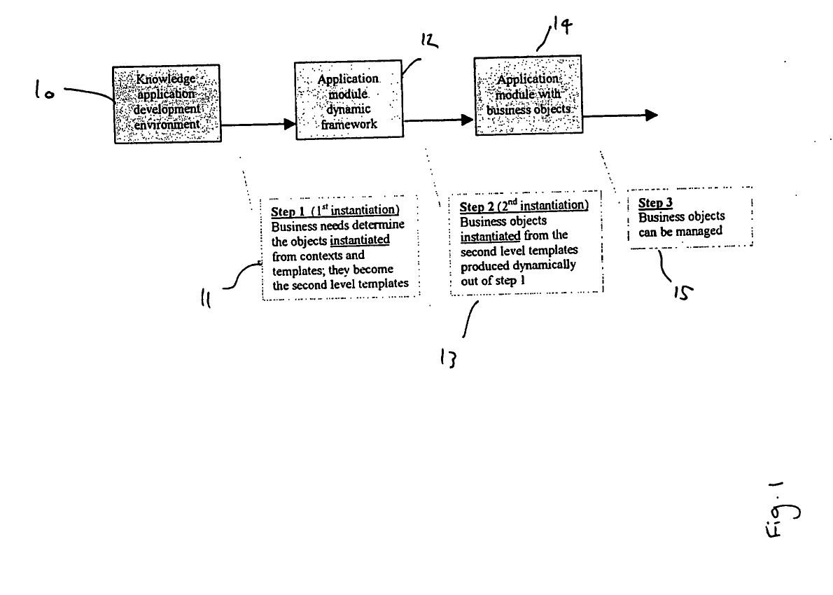

The process for building an adaptable software application will now be described with reference to FIG. 1. The process starts in a knowledge application development environment 10 where the business needs of the application determine the knowledge to be instantiated, or created, from contexts and templates. The first step 11 is the instantiation of this knowledge. The outcome is an application module dynamic framework 12 in which the kitems relate to the type of business objects or operations which will be handled by the adaptable software application.

This first step is distinguished from the construction of an application knowledge base since it does not produce the documents or the knowledge to be accessed via a consultation. Instead these kitems describe the application as a framework that will be used to generate the dynamic templates for the objects, documents, that relate to the application.

A second step 13 then involves populating the adaptable software application with business objects instantiated from contexts or templates produced in the first step. The process for defining these business objects is similar to defining an enquiry in a knowledge application. That is, parameters are specified that determine the features of the business object which is then created. The outcome is an application module 14 populated with business objects.

The business objects so created can be managed 15, that is accessed, edited, displayed, distributed, etc. These operations are simple to implement as they correspond to manipulating kitems, and they use standard kitem manipulation methods, and other specific methods if required. For example, the business objects could be accessed using a question-answer session.

Specific applications (or modules) are implemented by customising the generic framework produced in the first step, and this corresponds to instantiating different kitems as business objects for each application or module. This customizing can take place dynamically, during the use of the application. This corresponds to dynamic adaptation of the application to the needs of users.

Enquiries can be directed against both levels of instantiated kitems via a consultation process. Enquiries directed to the upper level of documents, produced by the first step, are typically used for inspecting and managing the design of the application.

To users, adaptable applications do not need to look different from normal applications. For example, a dialogue could take place that enquires about the needs or intentions of a user. Knowing the user's needs or intentions then enables the application to adapt or customize dynamically the template that is presented to the user; this templates defines the documents, or the type of documents, that the user enters into the application.

The two level instantiation process can also be described as cascading knowledge items. That is, some knowledge items determine which other knowledge items will be activated or instantiated to define documents. Applications can be built with a greater number of cascades or instantiations larger than two.

Most software applications are made of modules that communicate with each other. For example, a typical business management application is made of a client module, a project module, a contact module, a resource module and an accounting module.

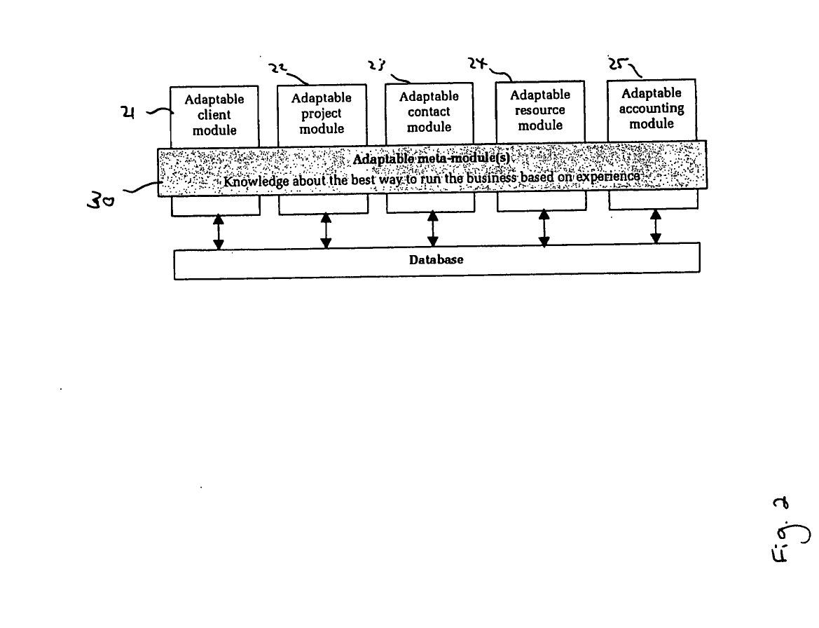

FIG. 2 shows adaptable, intelligent modules or agents. In particular there are adaptable intelligent client 21, project 22, contact 23, resource 24 and accounting 25 modules. Each module is adaptable. For example, in the client module, a different set of questions could be asked based on the age or location or socio-economic profile. Similarly for the other modules.

Each module has its business logic defined and implemented using an adaptable architecture. This means that each module can be quickly developed and that its functionality can evolve with the business and with experience. Each adaptable module implements the knowledge about the best way to run that module. These modules are used to facilitate development and to increase the functionality and adaptability of the solution.

Adaptable meta-module(s) 30 are used to define and implement the logic between the other modules. This could include workflow or project costing for example, where a client would be treated differently based on the number of projects commissioned in the past eighteen months and the success of these projects.

In addition the meta-modules are adaptable. In FIG. 2, the meta-module monitors a part of, or the whole chain of modules. For example, the accounting module may detect that some projects from some clients are not profitable. That means that the project module would need to be modified (using its adaptable feature) to ensure that these projects are run differently. It could also mean that additional information should be asked of these clients to perhaps rejects them as clients for a certain type of project. In this case the client module is modified using its adaptable feature.

A specific example is an access control database. All the operations possible with a database that needs to be controlled are listed as the context in a GKMS type application. Access is to be controlled for each group of users and for users in the groups (control is determined by the group and, in some cases, by the user). In this case, the first level of instantiation corresponds to defining the template to be used to give rights to each group of users. Each user, when linked to a group get an access rights document based on the template for the group it belongs to. This is the second level of instantiation. This document represents the right of that user. The administrator can then modify each document if desired to take account of the characteristics of the user within the group.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for constructing an adaptable software application, comprising the steps of:
instantiating a first set of kitems related to the type of business objects or operations which will be handled by the adaptable software application, from a knowledge application development environment identifying the business needs of the application; and,
instantiating a second set of kitems related to business objects, from the first set by specifying parameters to determine the features of the business objects.

2. A method according to claim 1, where the step of instantiating the second set of kitems occurs dynamically, during the use of the application.

3. A method according to claim 1, where further instantiating steps produce further sets of kitems from the immediately preceding set.

4. A method according to claim 1, comprising the further step of directing enquiries against kitems at any level of instantiation using a consultation process.

5. A method according to claim 1, comprising the further step of accessing the business objects using a consultation process during use of the application.

6. A method according to claim 1, comprising the further step of accessing kitems related to the type of business objects for the purposes of inspecting or managing the design of the application.

7. An adaptable software application, comprising:
at least two levels of instantiation, where the templates for the second level instantiations are the first level instantiations.

8. An application comprising adaptable, intelligent modules or agents that communicate with each other, where each module has its business logic defined and implemented using the adaptable system of claim 7.

9. An application according to claim 8, further comprising adaptable meta-module to define and implement the logic between the other modules.

10. An application according to claim 9, where the meta-module monitors a part of, or the whole chain of modules.
